(19) United States
(12) Patent Application Publication
(10) Pub. No.: US 2020/0110914 A1
(43) Pub. Date: Apr. 9, 2020

(54) System and Methods for Centralizing Document Annotation

(71) Applicants: Michael James MacKay, Hudson, NH (US); Kwasi Yeboah Oppong-Badu, Union, NJ (US); Uday Raj Singh, New York, NY (US)

(72) Inventors: Michael James MacKay, Hudson, NH (US); Kwasi Yeboah Oppong-Badu, Union, NJ (US); Uday Raj Singh, New York, NY (US)

(21) Appl. No.: 16/529,785

(22) Filed: Aug. 1, 2019

(51) Int. Cl. G06F 40/169; G06F 40/197; G06F 16/176; G06F 16/16; G06F 16/93

(52) U.S. Cl. CPC G06F 40/169; G06F 40/197; G06F 16/93; G06F 16/168; G06F 16/1767

(57) ABSTRACT

Epigrammar is a cloud-based software application that lets users on a multi-user access document retrieve annotations from closed files for reuse on an open file and retrieve annotations from closed files for reuse on a new document (i.e. log). When users or authorized users make an annotation (called an, “Epigram,” online) on some file that has been shared to Epigrammar in any file format, that annotation and its relevant data are stored in a general repository providing context for the note. Thus, users never need to open an annotation's corresponding file in order to recover valuable information. Due to mapping information stored in the form of x- and y-coordinates, the precise point of any annotation may be found by selecting any annotation from a general inventory of annotations to facilitate activity online. That portable and searchable repository serves as both a navigation tool and index, and with features for tagging and automatically organizing notes, Epigrammar centralizes document annotation online.

### FIELD OF THE INVENTION

The present invention generally relates to document annotation in a computing environment.

### BACKGROUND

The Internet lets users share documents in real-time. Documents can take many file formats, but when viewed through web browsers or other web-based software applications, document annotation usually requires a parser for text. Native applications of word processing software or other applications that run on the cloud often involve a parser for text, so whether offline or online, users of such applications must highlight words in order to make annotations (i.e. notes associated with a particular part of a file). Alternatively, some applications might enable users to draw rectangular areas onto a web-based document and associate the enclosed area with an annotation. Yet, notwithstanding a variety of protocols for note-taking, all prior art lacks an apparatus for retrieving and recycling annotations. As such, when users annotate different files, their corpus of annotations becomes increasingly decentralized.

Without a general system or methods for centralizing document annotation, the obsolescence of annotations is inevitable, as users are forced to individually open files in order to retrieve and recycle the contents of annotations. To that end, searching for annotations generally entails scrolling through the margins, so in the unlikely event that annotations are not lost completely, they are at least jeopardized by a capricious process for review. Despite the fact that existing software applications lack a mechanism for streamlining document annotation, there is significant demand from a myriad of sources for better tooling. Many industries now handle vast volumes of annotations made digitally, and in this capacity, there is a need to improve their system and methods for centralizing document annotation across a range of online activity. Perhaps nowhere is an innovative process more needed than in the field of education.

### BRIEF DESCRIPTION OF THE DRAWINGS

Different embodiments in accordance with the present disclosure will be outlined with reference to the drawings, in which:

FIG. 1 shows a process for retrieving and recycling annotations by means of a web-based software application, in accordance with one embodiment.

FIG. 2 shows a block diagram of the network architecture supporting a web-based software application, according to one embodiment.

FIG. 3 shows a block diagram of a client device, according to one embodiment.

FIG. 4 shows a data structure of a user record, which is used to store information in a user information database, according to one embodiment.

FIG. 5 shows a data structure of an environment record, which is used to store information in a user information database, according to one embodiment.

FIG. 6 shows a data structure of a file record, which is used to store information in a user information database, according to one embodiment.

FIG. 7 shows a data structure of a user record, which is used to store information in a user information database, according to one embodiment.

FIG. 8 shows a data structure of a log record, which is used to store information in a user information database, according to one embodiment.

FIG. 9 shows a process for recycling annotations while reviewing an open file with multi-user access, in accordance with one embodiment.

FIG. 10 shows a process for recycling annotations while reviewing an environment, user, or closed file with multi-user access, in accordance with one embodiment.

FIG. 11 shows an example of a user interface for annotating an open file with multi-user access, according to one embodiment.

FIG. 12 shows an example of a user interface for reviewing annotations on an open file with multi-user access and discussing a selected annotation, according to one embodiment.

FIG. 13 shows an example of a user interface for navigating an open file with multi-user access, a mechanism for retrieving annotations from closed files for the sake of recycling their contents, and a route to locating a new addition to the active corpus of annotations, according to one embodiment.

FIG. 14 shows an example of a user interface for annotating audio or video shared via link with multi-user access, according to one embodiment.

FIG. 15 shows an example of a user interface for retrieving annotations from an indexed inventory and recycling an annotation or set of annotations into a new document, according to one embodiment.

FIG. 16 shows an example of a user interface for editing or exporting a document created from a retrieved annotation or set of annotations, according to one embodiment.

### DETAILED DESCRIPTION OF THE DRAWINGS AND BEST MODE OF IMPLEMENTATION

### Introduction

The present invention fulfills this need in the art by (1) allowing users to retrieve any annotation without opening its corresponding file and recycle the retrieved annotation as part of some new document and (2) allowing users to retrieve any annotation without opening its corresponding file and recycle the retrieved annotation on a different file being annotated.

Systems Architecture

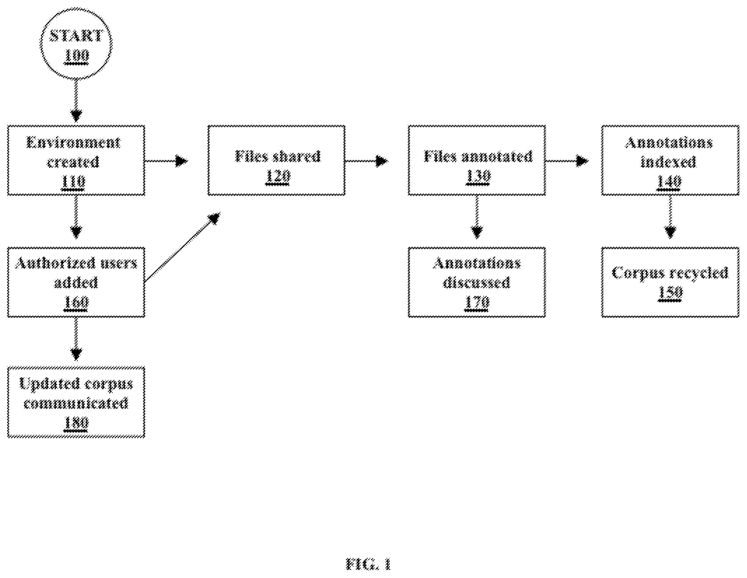

FIG. 1 shows a process for retrieving and recycling annotations by means of a web-based software application, in accordance with one embodiment. In general, the process starts when the first user 100 creates an online environment 110 by signing up for the cloud-based software application 240 or, if an account already exists for that user, logging into the application and subsequently creating an online environment for document annotation. In that online environment, the first user 100 then shares files in any format (e.g. .pdf, .doc, .jpg, .mp4, .wav, etc.) by uploading files or sharing links to files hosted elsewhere online. The first user 100 then proceeds to annotate shared files 130 in accordance with the user interface variously illustrated in subsequent figures. Each annotation made in the online environment is automatically indexed 140 for rapid reuse 150, whereby the first user 100 may reassign prior annotations to different documents or generate new documents altogether from prior annotations. Furthermore, the first user 100 may authorize additional users to partake in document annotation by sending them an invitation code unique to that online environment 110, which an authorized user can then enter by signing up for the cloud-based software application 240 or, if an account already exists for that authorized user, logging into the application and subsequently joining with the code where prompted. Like the first user 100, authorized users may create additional online environments for their own purposes, and users will receive notifications regarding changes to the developing corpus of annotations 180 for any online environment that they create. Unlike the first user 100, authorized users may only access an inventory of annotations, for which they have permission or authorship (e.g. an authorized user may share a file with user 100 and retain all its annotations). For example, if an authorized user comments on another authorized user's annotation, that discussion 170 will appear to the latter and the first user 100 as a notification 180, since the first user 100 created the online environment. In general, a user will be notified about changes to an active corpus of annotations 180 based on that user's relation to the online environment 500, shared file 600, or annotation 700. Under certain circumstances as permitted by the first user 100, authorized users may share files 120, make annotations 130, or recycle annotations that have been automatically indexed 140. Similarly, authorized users may discuss annotations 170 or recycle prior annotations from their own corpus of annotations 150 for the sake of annotating different documents or generating new documents altogether.

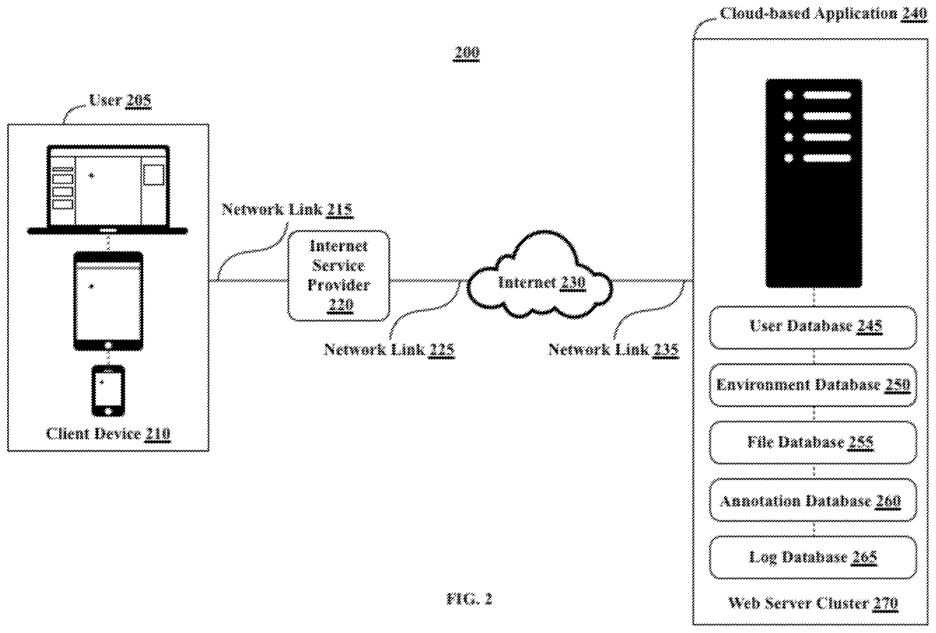

FIG. 2 shows a block diagram of the network architecture supporting a web-based software application, according to one embodiment. In one embodiment, user 205 uses one of several client devices 210 that can annotate some document when logged into a cloud-based software application 240. Through network link 215, Internet service provider 220, network link 225, the Internet 230, and network link 235, the annotations made by user 205 are sent to an annotation database 260. Given the variety of client devices, network links may constitute ATM/SONNET, cable networks, DSL, telephone lines, T1 lines, wireless networks, or any other arrangement that allows for the transmission and reception of network signals. Notably, user 205, Internet service provider 220, and Web server cluster 270 are rightly considered part of the Internet 230 because of their connectivity. Nonetheless, stages in the transmission of data and metadata 200 are separated for clarity.

According to one embodiment, cloud-based application 240 receives the annotated file through its Web server cluster 270, which may comprise a collection of Web server computers working in tandem to distribute the load of network traffic. These Web servers include processors and memory for executing program instructions as well network interfaces. Cloud-based application 240 also comprises, among other components, user database 245, environment database 250, file database 255, annotation database 260, and log database 265. Those skilled in the art realize that these single-record databases may be represented in many different ways, including but not limited to individual tables in one or more relational databases. While all annotation-related information is sent to the cloud-based application 240, some information may also be stored in resident storage device 320 for efficiency reasons.

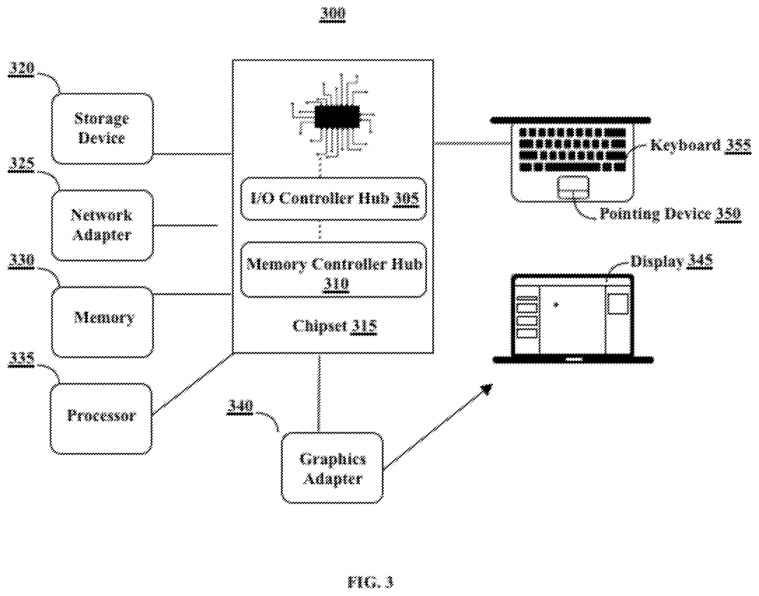

FIG. 3 shows a block diagram of a client device 210 used in the networked computing environment of FIG. 2, according to one embodiment. Illustrated are at least one processor 335 connected to a chipset 315. The chipset 315 includes a memory controller hub 310 and an input/output (I/O) controller hub 305. A memory 330 and a graphics adapter 340 are coupled to the memory controller hub 310, and a display device 345 is coupled to the graphics adapter 340. A storage device 320, keyboard 355, pointing device 350, and network adapter 325 are coupled to the I/O controller hub 305. Other embodiments of the computer 300 have different architectures. For example, the memory 330 is directly coupled to the processor 335 in some embodiments. The storage device 320 includes one or more non-transitory computer-readable storage media such as a hard drive, compact disk read-only memory, DVD, or a solid-state memory device. The memory 330 holds instructions and data used by the processor 335. The pointing device 350 is used in combination with the keyboard 355 to input data into the computer system 300. The graphics adapter 340 displays images and other information on the display device 345. In some embodiments, the display device 345 includes a touch screen capability for receiving user input and selections. The network adapter 325 couples the computer system 300 to the network 215. Some embodiments of the computer 300 have different and/or other components than those shown in FIG. 3. For example, the client device 210 can be a smartphone or tablet and include a touch-screen that provides an on-screen keyboard akin to a pointing device 350 in terms of functionality. The computer 300 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 320, loaded into the memory 330, and executed by the processor 335.

Database Design

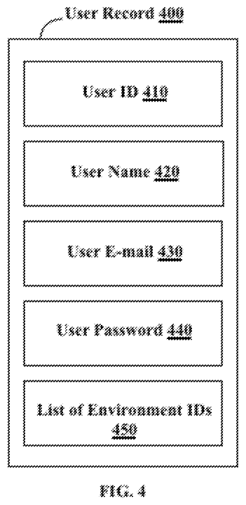

FIG. 4 shows a data structure of a user record, which is used to store information in a user information database, according to one embodiment. Each user record 400 represents a single unique user of the cloud-based software application 240, and a user record 400 is created when a user creates an account online. In particular, user record 400 includes a user ID 410 field, user name 420 field, user e-mail 430 field, user password 440 field, and list of environment IDs 450 field. User ID 410 contains an integer value that identifies each user record 400 in user information database 245. User name 420 contains a unique UTF-8 string that represents each user 205 associated with the cloud-based application 240. User e-mail 430 contains a unique UTF-8 string that represents the e-mail address of each user 205 associated with the cloud-based application 240. User password 440 contains a unique UTF-8 hashed string chosen for security purposes by each user 205 associated with the cloud-based application 240. The password may be encrypted using any standard UNIX utility including crypt or salt. The list of environment IDs 450 contains a list of references to records stored in the environment database 250.

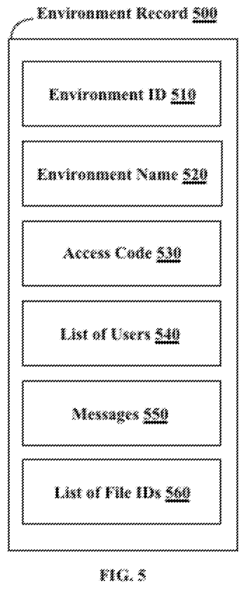

FIG. 5 shows a data structure of an environment record, which is used to store information in an environment database, according to one embodiment. Each environment record 500 represents a single unique environment of the cloud-based software application 240, and an environment record 400 is created whenever a user creates an environment online. In particular, the environment record 500 includes an environment ID 510 field, environment name 520 field, unique access code 530 field, list of users 540 field, messages 550 field, and list of file IDs 560 field. The unique access code 530 is automatically generated by the cloud-based application but can be regenerated at any time by the first user 100. Authorized users need not enter an access code more than once in order to join an online environment; however, the first user 100 to that environment may remove any authorized user from that environment, in which case an authorized user would need to re-enter that environment. Correspondingly, any changes to the roster of authorized users are reflected in the list of users 540 field. Furthermore, each environment has an online forum, which permits messages 550 between users in the form of chat. Environment ID 510 contains an integer value that identifies each environment record 500 in the environment database 250, and environment name 520, as chosen by each user 205, contains an UTF-8 String. The list of file IDs 560 contains a list of references to records stored in the cloud based-application 240.

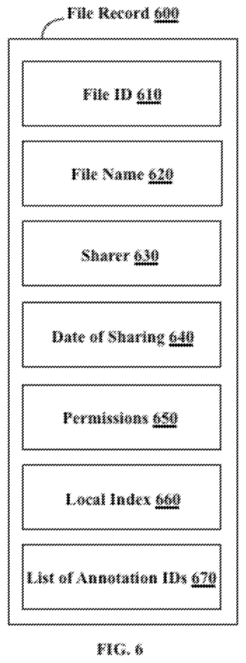

FIG. 6 shows a data structure of a file record, which is used to store information in a file database, according to one embodiment. Each file record 600 represents a single file shared with the cloud-based software application 240, and a file record 600 is created whenever a user uploads a file or shares a file via link to some online environment. In particular, the file record 600 includes a file ID 610 field, file name 620 field, sharer 630 field, date of sharing 640 field, permissions 650 field, local index 660 field, and list of annotation IDs 670 field. File ID 610 contains an integer value that identifies each file record 600 in the file database 255, and file name 620, as chosen by each user 205, contains an UTF-8 String. The sharer 630 is determined by the user who shares the file for document annotation, and the date of sharing 640 indicates when the file first became available for document annotation in the environment. When each user 205 shares a file, the user also sets permissions 650, which enable different levels of interactivity among various users annotating a file. For example, a sharer 630 may designate a file's permissions as flat or tiered: in a flat mode, all users may view or discuss any annotation made on the file, but in a tiered mode, only the sharer 630 can view or discuss any annotation made on the file, whereas the remaining users can view or discuss their own annotations or else the sharer's, unless the sharer has promoted them to the sharer's tier. Additionally, permissions 650 grant the sharer 630 certain privileges in setting points or tags for use in annotating a file (e.g. on a file with multi-user access, the sharer 630 can choose to limit tags to those that the sharer 630 has approved). The local index 660 provides a range of numeric values for a shared file's set of annotations based on a clustering algorithm, which determines the similarity of annotations by processing data from the annotations referenced by the list of annotation IDs 670 containing a list of references to records stored in the cloud based-application 240.

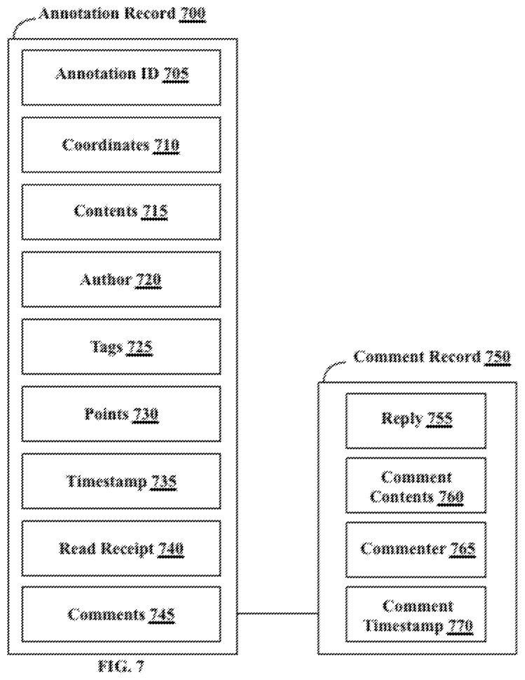

FIG. 7 shows a data structure of an annotation record that is used to store information in the annotation database 260, according to one embodiment. Each annotation record 700 contains pertinent information relating to a particular point on a shared file, and an annotation is recorded in the annotation database 260 whenever a user interacts with a shared file's document viewer or media-player and saves the corresponding annotation on the cloud-based software application 240. In particular, an annotation record 700 includes an annotation ID 705 field, coordinates 710 field, contents 715 field, author 720 field, tags 725 field, points 730 field, timestamp 735 field, read receipt 740 field, and comments 745 field, which references to a corresponding comment record 750 field comprised of a reply 755 field, comment contents 760 field, commenter 765 field, and comment timestamp 770 field. The annotation ID 705 contains an integer value that identifies each annotation record 700 in the annotation database 260. The x- and y-coordinates are chosen by each user 205 using the pointing device 350 to place an annotation anywhere in the document viewer or media-player. The contents 715 of an annotation are created by each user 205 using the pointing device 350 or keyboard 355, and in the example of text, formatting attributes such as bold, italics, or underline may be retained in the annotation database 260. In the example of attaching audio or video contents, such text formatting attributes are not retained where there are not typed words. The author 720 is the creator of an annotation, and the tags 725 applied to an annotation may be selected from tags set by the sharer 630. Similarly, points 730 may be applied to an annotation based on certain permissions 650 for that file. Every annotation has a timestamp indicating when the author 720 first saved the annotation to the annotation database 260, and whenever a user edits an annotation, information regarding the timestamp and edited status is updated. Since some annotations have comments 745, some annotations also have a secondary record, because comments are treated as a secondary class of annotations, for which only information regarding the annotation ID 705 or comment record 750 to which a comment replies 755 as well as the latter comment's contents 760, author 765 (i.e. commenter), and timestamp 770 are stored in the annotation database 260. The read receipt 740 records which user has seen an annotation once some user 205 has selected another user's point in the document viewer or media-player or selected an annotation not authored by the user from the file's inventory of annotations and thereby navigated to that point. Thus, user 205 can determine whether or not an annotation has been read by an authorized user; by extension, read receipts have a null value in an environment without more than one user.

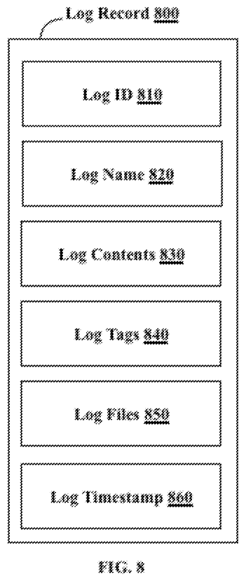

FIG. 8 shows a data structure of a log record, which is used to store information in a log database, according to one embodiment. Each log record 800 represents a single document created from an existing annotation or set of annotations stored on a cloud-based software application 240. In particular, the log record 800 includes a log ID 810 field, log name 820 field, log contents 830 field, log tags 840 field, and log files 850 field. The log ID 810 contains an integer value that identifies each log record 800 in the log database 265. The log name 820, as chosen by each user 205, contains an UTF-8 String. The log contents 830 are created by each user 205 using the pointing device 350 or keyboard 355, and in the example of text, formatting attributes such as bold, italics, or underline may be retained in the log database 265. In the example of attaching audio or video contents, formatting attributes are not retained where there are not typed words. The log tags 840, as chosen by each user 205, may be set by the logger, and log files 850, as chosen by each user 205, may be sourced from recycled annotations or reset by the logger. Log timestamp 860 indicates when a log was last saved.

Annotation and Log Protocols

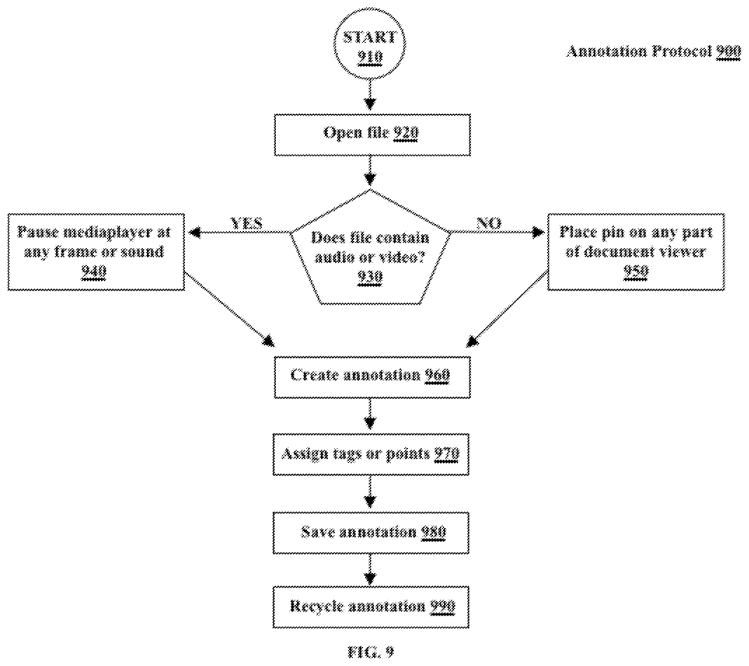

FIG. 9 shows a process for recycling annotations while reviewing an open file with multi-user access, in accordance with one embodiment. In general, the annotation protocol 900 begins when the user 910 opens a file shared on the cloud-based software application 240. If the file contains audiovisual content, then the user 910 can use the pointing device 350 or keyboard 355 to pause the media-player 940 to annotate the file at a certain point along the x-axis representing time. However, if the file does not contain audiovisual content, then the user 910 must use the pointing device 350 to place a pin anywhere within the document viewer's xy-plane representing space. Once the user 910 has marked a location, the user 910 may also use the keyboard 355 to begin typing into the textbox in order to create an annotation 960 (n.b. text or attachments are recorded as contents 715). Alternatively, the user 910 may attach an audio or video file where prompted in the textbox 960. Additionally, the user 910 may assign tags or points 970 depending on the file's permissions 650 as set by the sharer 630. Once the user has finished making an annotation, the user 910 must save the annotation 980. Then, the user can recycle that annotation 990 by repeating steps 930, 940, and 950. For example, the user 910 who has completed the annotation protocol and selected a new point in the document viewer 950 can click on any annotation in their inventory to automatically populate the textbox with the prior annotation. Similarly, the user 910 who has completed the annotation protocol can open another file 920, pause the media-player at any frame 940 and click on any annotation in their inventory to automatically populate the textbox with the prior annotation.

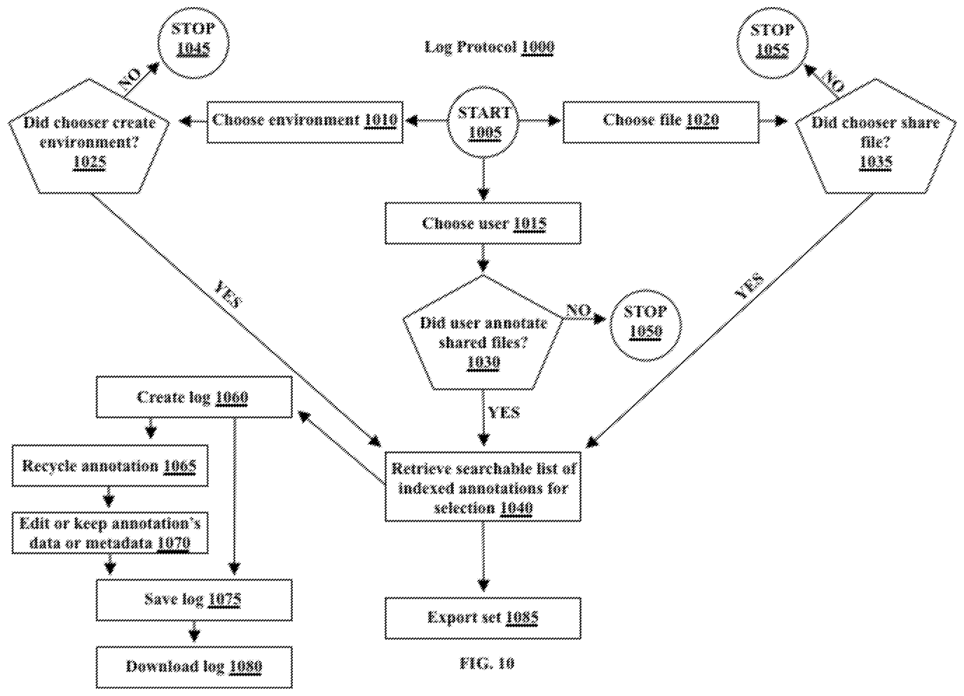

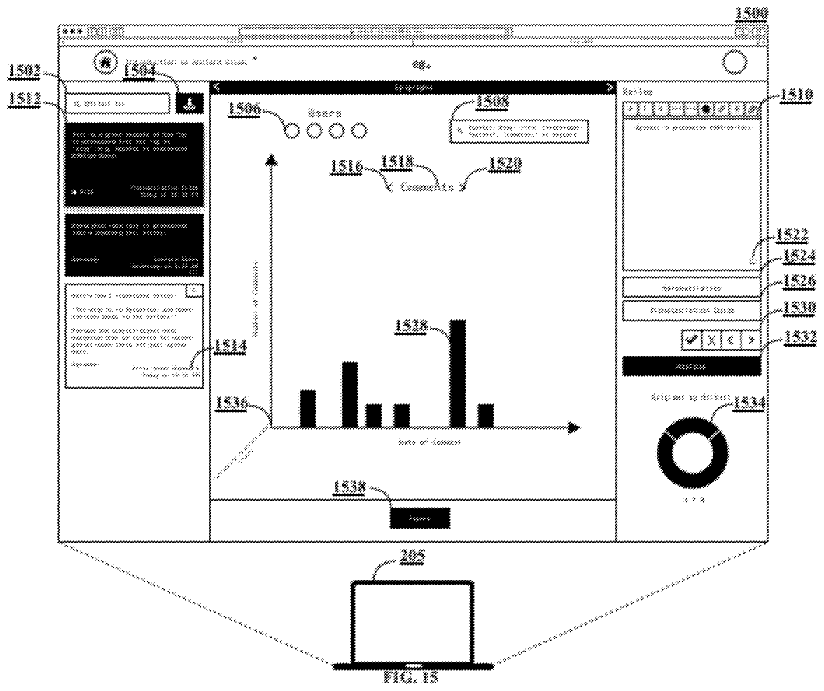

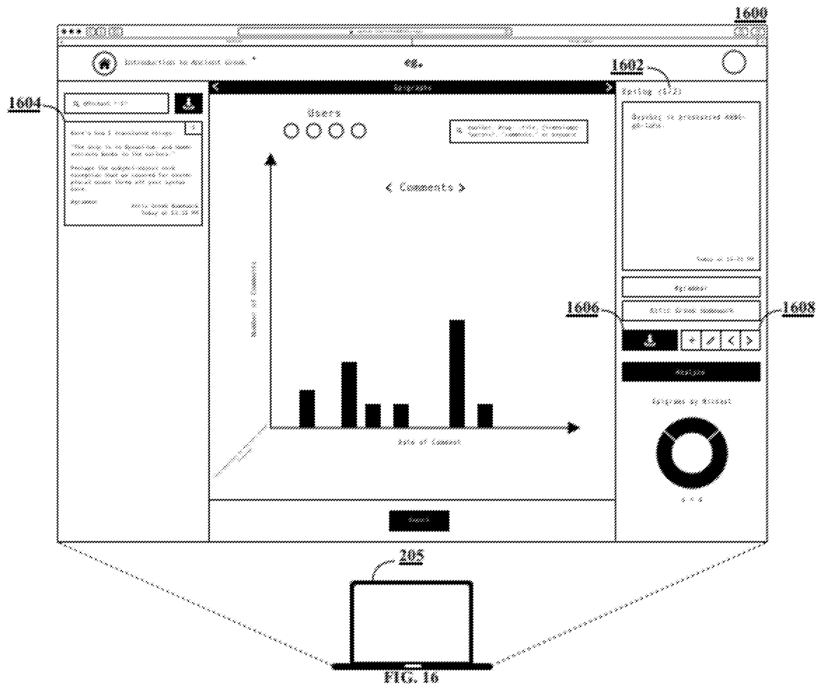

FIG. 10 shows a process for recycling annotations while reviewing an environment, user, or closed file with multi-user access, in accordance with one embodiment. In general, the log protocol 1000 begins in the analytics dashboard featured in FIG. 15 and FIG. 16 where the user 1005 chooses an environment 1010, user 1015, or file 1020. If and only if the user 1005 established the environment 1025 can a searchable list of indexed annotations for the entire range of shared files and annotations made by users be retrieved 1040. If the user 1005 did not create the environment 1045 but shared a file or set of files with that environment 1035, then the user 1005 can choose the file or set of files shared 1020 and retrieve a searchable list of indexed annotations for the selection 1040. If the user 1005 did not share files 1055 or create an environment 1045 but made annotations of some shared files in the environment 1030, then the user 1005 can retrieve a searchable list of indexed annotations for the selection 1040. Otherwise, if the user has not created an environment 1045, shared files 1055, or made annotations 1050, then the user will not be able to retrieve a searchable list of indexed annotations for the selection 1040. However, if a searchable list of annotations has been retrieved 1040, then the user 1005 can create a log 1060. Notably, the algorithm that is used to calculate the Local Index 660 is also used to dynamically index the corresponding set of annotations by similarity, wherein clusters are ranked in descending order of their size. Similar to the annotation protocol 900, the log protocol utilizes the same user interface, whereby the user 1005 may select any annotation from the corresponding inventory to recycle that annotation in the textbox 1065. Moreover, the user 1005 can edit or keep the annotation's contents 830, tags 840, or files 850 for the log, which must be saved 1075 in order for the log record 800 to be stored in the log database 265. The user 1005 may also move documents offline by downloading any log 1080 generated on the cloud-based software application 240.

User Interface for Retrieving and Recycling Annotations

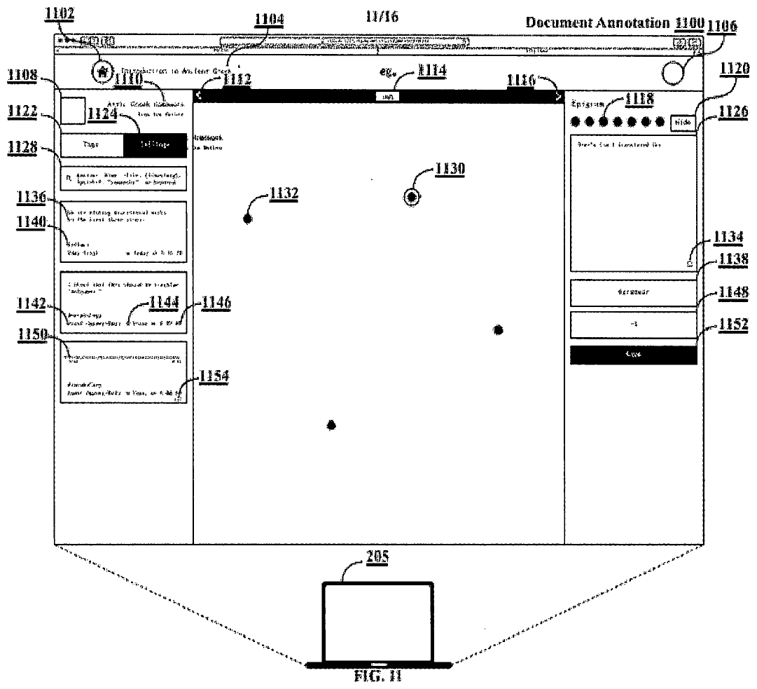

Referring now to FIG. 11, there is shown an example of a user interface for annotating an open file with multi-user access, according to one embodiment. In this example, user 205 is conducting document annotation 1000 on an open file being displayed in the document viewer 1114—to enhance that view, user 205 may also change the zoom or toggle the arrows 1112 and 1116, which close the left- and right-hand panels. The shared file entitled “Attic Greek Homework” 1110 has received a transparent overlay from the cloud-based software application 240. Notably, the text or images of “Attic Greek Homework” have been hidden from view in order to enhance the clarity of the present disclosure, but those features would be viewable by the user online. Thus, user 205 is following the annotation protocol 900 as previously outlined: user 205 has affixed a point 1130 to the xy-plane 950 by using the pointing device 350 and begun typing into the textbox 1126 by using the keyboard 355. Additionally, user 205 has already assigned # grammar 1138 and a negative point (−1) 1148 to the annotation being made, but neither tags nor points need be assigned first and can be completed after contents 715 of an annotation have been created. Here, it appears user 205 is foregoing an attachment of audio or video 1134 to the annotation, so once user 205 has finished typing, the annotation record 700 may be saved by clicking 1152 (or pressing “shift+enter” by using the keyboard 355). Once the annotation at that point 1130 has been saved, it will stop pulsating and resemble the adjacent point 1132 in that regard. If user 205 wants to hide annotations from view, the user 205 need only toggle “Hide” 1120. Likewise, if the user wants to change the color of points in the document viewer (e.g. the file is predominantly purple, which also happens to be the default color for points such as 1132 or 1130), then the user need only select a shade along the line of colors 1118 to reconfigure the display.

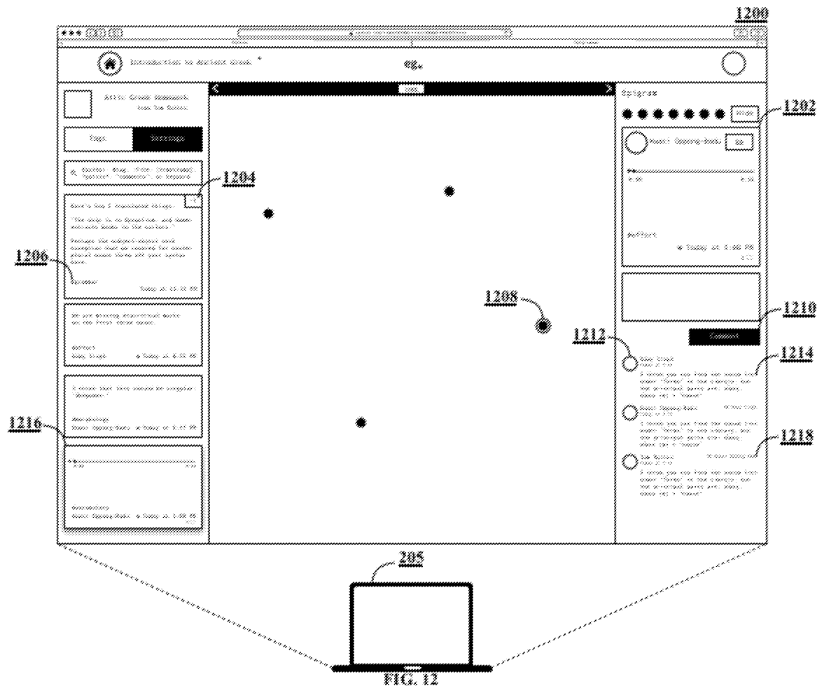

Moreover, any new annotation will be displayed in the left-hand panel, which also features information regarding the file name 620, sharer 630, and thumbnail 1108. Importantly, each file contains a search bar 1128 for commands including @author, # tag, :file, [timestamp], *points*, “comments,” or keyword. For reference, a compound search and its corresponding results are illustrated in FIG. 15 and FIG. 16, but any command or combination of commands may be used as part of a compound search. Below the search bar 1128, user 205 finds a list of three annotations already present on the file. The contents 1136 and tag 1140 of one annotation indicate how the annotation being created by user 205 will look upon saving 1152. However, there will be one cosmetic difference: since user 205 will be the author 720 of the annotation, the user name 420 of the sharer 630 will not appear below the tag (if any is assigned). Yet, similarly, a timestamp 1146 will be displayed as well as a read receipt 1144 with a scroll-over effect indicating when other users have selected that annotation from either their inventory of annotations or else the document viewer. Notably, as demonstrated in FIG. 12, any point in the document viewer may be navigated to by selecting the corresponding annotation from the inventory of annotations present on the file or vice-versa. The audio attachment 1150 shows how attachments may be displayed as contents 715 of an annotation, and that annotation also shows how the number of comments 1154 may be conveyed to user 205.

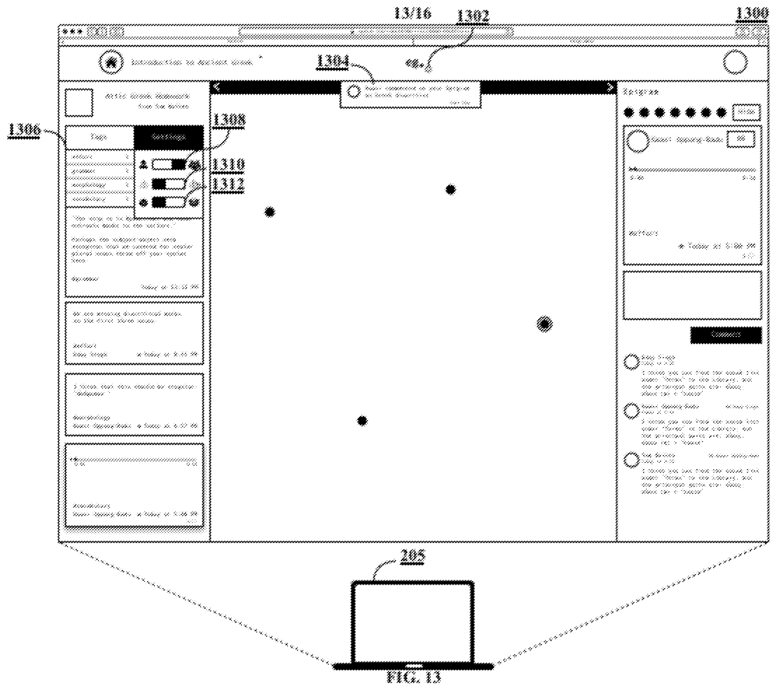

If user 205 chooses to exit the file being annotated, user 205 may select home 1102 to revisit the main dashboard for the environment, and the user 205 may also change environments altogether by selecting another environment from the drop-down menu 1104 or navigating elsewhere in the account from user settings 1106. Permissions 650 may also be adjusted in “Settings” 1124, which will be outlined in greater detail in FIG. 13.

FIG. 12 shows an example of a user interface for reviewing annotations on an open file with multi-user access and discussing a selected annotation, according to one embodiment. In this example, user 205 has selected annotation 1216, as indicated by the slight shadow around the annotation. Correspondingly, point 1208 has been illuminated, and the right-hand panel has been populated with its relevant data. The annotation is expanded in 1202 to include other fields such as the author's avatar next to the author's user name as well as the total number of annotations for that author. If user 205 would like to comment on the annotation, user 205 would write in the textbox below the annotation and select comment 1210 when done. However, if user 205 would like to comment in the annotation's threaded discussion, then user 205 could reply to any commenter. There is no indentation in the threaded discussion in order to preserve screen space, but as in 1218, a record exists of whom the commenter has addressed and a scroll-over effect over the addressee indicates which comment exactly is being addressed. Thus, the comment's contents 1214 may be edited like an annotation, and like an annotation, the author (or commenter) and timestamp also appear near the appropriate avatar 1212. Notably, the annotation that was being made in FIG. 11 has now also been saved, and its tag (# grammar) 1206 and point (−1) 1204 are finally viewable in the left-hand panel.

FIG. 13 shows an example of a user interface for navigating an open file with multi-user access, a mechanism for retrieving annotations from closed files for the sake of recycling their contents, and a route to locating a new addition to the active corpus of annotations, according to one embodiment. In the example, the user 205 remains on annotation 1208 but has now opened the “Tags” 1306 and “Settings” 1124 drop-down menus. In “Tags,” user 205 sees an inventory of the quantity and variety of tags that have been assigned to annotations on the open file. In “Settings,” user 205 sees three toggles, one of which has already been selected. The selected toggle 1308 indicates the permissions assigned by sharer 630 to “Attic Greek Homework.” Therefore, in this example, the file has been shared in a flat mode, as indicated by the multiple users who have commented on annotation 1208 as well as, of course, the icon of many users in a group toward which the toggle is switched. Toggle 1310 activates the front-end demonstration of the Local Index, which colorizes points in the document viewer as well as annotations in the inventory (n.b. an example of how similar annotations are illuminated in the inventory is illustrated in FIG. 15). Thus, every point is colorized, such that red annotations mark the largest cluster of similar annotations and violet marks the smallest cluster—intermediate clusters resemble the spectrum of a light prism. Furthermore, toggle 1312 activates the additional retrieval of closed files' annotations (n.b. an example of how other annotations enter the inventory occurs in FIG. 15 where 1514 lists the provenance of an annotation to be reused by user 205). As noted in the annotation protocol 900, user 205 need only select an annotation from the inventory in order to repopulate its contents, tags, or points in the right-hand panel. Yet, when annotations from closed files have been retrieved for the sake of recycling prior contents on an open file, only annotations currently on that file will be navigable in the inventory as aforementioned; ergo, prior annotations can be selected with the pointing device 350 and reused. Additionally, it appears that user 205 has either shared the file “Greek Diacritics,” made an annotation on “Greek Diacritics,” or created the environment “Introduction to Ancient Greek,” since user 205 has received one update 1302 regarding a change to the active corpus of annotations and upon selecting that update seen a summary 1304, which can further navigate user 205 to that addition to the corpus upon selection.

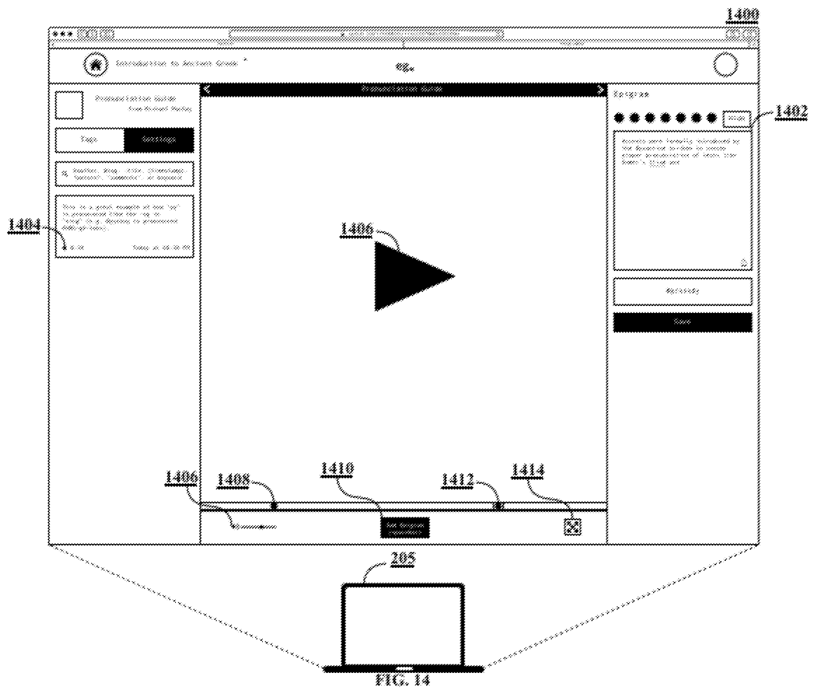

FIG. 14 shows an example of a user interface for annotating audio or video shared via link with multi-user access. In the example, user 205 is annotating video displayed by a media-player. It appears that user 205 has not yet saved the annotation, which seems incomplete in the textbox 1402 and not yet pinned 1412 to the media-player like another annotation 1408. Clearly, user 205 is creating an annotation per step 940 of the annotation protocol 900, since the media-played has been paused and must be played 1406 in order to resume watching (i.e. the annotation protocol 940 requires that user 205 pause to annotate). To make an annotation, user 205 must then either click the media-player while an audio or video file is playing or press the spacebar 1410 to pause activity. Any annotation saved to the x-axis, which represents time, will appear as a mark 1408 on the media-player for that frame. Additionally, user 205 may navigate to any marked section of an audio or video file by selecting an annotation's playback icon 1404 similar to how in FIG. 12 user 205 could navigate to point 1208 by selecting annotation 1216. The same rules for “Tags” and “Settings” govern document annotation from 1100 through 1400, but with audio or video files, user 205 can also adjust the volume 1406 or play the files in theater mode 1414 (i.e. full-screen).

FIG. 15 shows an example of a user interface for retrieving annotations from an indexed inventory and recycling an annotation or set of annotations into another document, according to one embodiment. In the example, user 205 is viewing the main analytics panel for “Introduction to Ancient Greek.” Apparently, user 205 has created the environment, because user 205 is able to see all users 1506 for that environment (see Log Protocol 1000). By selecting an avatar for an authorized user or avatars for a set of authorized users, user 205 can filter out data from other authorized users in the central data visualization. Moreover, user 205 can analyze any set annotations for similarities by applying the clustering algorithm behind the Local Index 1532. Once the new set of data is scored, clusters of annotations will be listed in descending order of the largest and least idiosyncratic cluster. For example, the colorized annotation 1512 apparently comes from a cluster with more similar members than the less colorized annotation below. When user 205 wants to generate a document from an annotation or set of annotations then, user 205 need only select an annotation or as many as annotations as desired from the left-panel (similar to the annotation protocol 800, if more than one annotation has been selected, subsequent annotations will fill out the textbox 1510 and corresponding fields for log tags 1524 and log files 1526). If an annotation has an attachment, that attachment will be included, but another attachment 1522 may always be added to a prior annotation that has been recycled. Once user 205 has found an annotation, user 205 may conduct a compound search 1502 in order to filter out irrelevant fields, and user 205 can then partially or fully recycle the contents, tags, and files of annotation to form a log. In the case provided, user 205 has selected 1512 and edited out some of the prior annotation's contents but retained its tag and file. Once user 205 is satisfied with the substance and style of that log, user 205 must select the checkmark below the field for log tags 840 and log files 850 in order to save that log record 800 in the log database 265. To facilitate document annotation, the cloud-based software application 240 also provides several data visualizations for users. A graph on “Comments” 1518 tracks how many annotations with comments have been made over time by plotting data from comments over data from timestamps (the onset of such tracking over time is usually marked by the creation of an online environment 1536). Nonetheless, many data visualizations are available to users and may be cycled through by selecting the arrows 1516 and 1520 leading to different graphs and charts. Moreover, irrelevant data can be filtered out by applying certain search commands 1508. For example, in the case provided, user 205 has selected “Michael,” so user 205 sees a chart 1534 corresponding to Michael's annotations that features divisions based on tag, where one out of four of Michael's annotations has a unique tag. Lastly, user 205 may export any subset of annotations by pressing the download button for annotations 1504 or export the entire set of annotations for the environment by pressing the export button 1538.

FIG. 16 shows an example of a user interface for editing or exporting a document created from a retrieved annotation or set of annotations, according to one embodiment. In the example, user 205 has successfully generated a log record, as indicated by the updated range of log records 1602. User 205 can also change or remove the name of that log or its contents by selecting the pencil icon from the log toolkit 1608. Moreover, user 205 can add another log by selecting the plus icon from the log toolkit 1608. If user 205 wants to move logs offline, user 205 can export all log records by selecting the download button for logs 1606. Notably, user 205 can always query a subset of annotations, as demonstrated by the annotation now atop the inventory 1604, no matter whether the log protocol 1000 has been seen through fruition.

What is claimed is:

1. A method for managing revisions to multi-user access to a common document, the method comprising:
receiving, from each of a plurality contributors to the common document, a signal indicating a point location on the common document and an annotation to be applied to the common document at the point location;
storing document coordinates representing the point locations and the annotations associated with each point location separately from the common document;
providing one or more users with access to the stored coordinates and annotations;
receiving from at least one of the one or more users, a request to reuse one or more of the annotations on a document other than the common document without requiring access to the common document.

2. A method for managing revisions to multi-user access to a common document, the method comprising:
receiving, from each of a plurality contributors to the common document, a signal indicating a point location on the common document and an annotation to be applied to the common document at the point location;
storing document coordinates representing the point locations and the annotations associated with each point location separately from the common document;
providing one or more users with access to the stored coordinates and annotations such that the one or more users can visually navigate the common document using the stored coordinates and annotations.

3. A method for managing revisions to multi-user access to a common document, the method comprising:
receiving, from each of a plurality contributors to the common document, each independently accessing the common document, a signal indicating a point location on the common document and an annotation to be applied to the common document at the point location, wherein a first contributor to the common document is identified as a first tier user and subsequent contributors are identified as subordinate users;
storing document coordinates representing the point locations and the annotations associated with each point location separately from the common document;
providing at least one of the subsequent users with access to a subset of the stored coordinates, the subset limited to annotations received from the first user and the at least one of the subsequent users.
